(19) United States
(12) Patent Application Publication
(10) Pub. No.: US 2025/0381447 A1
(43) Pub. Date: Dec. 18, 2025

(54) MODULAR FITNESS MONITORING SYSTEM

(71) Applicant: YGYM LLC, Chicago, IL (US)

(72) Inventors: Tyler Sauter, Chicago, IL (US); Isaiah Anderson, Chicago, IL (US)

(21) Appl. No.: 19/178,079

(22) Filed: Apr. 14, 2025

Related U.S. Application Data
(60) Provisional application No. 63/633,481, filed on Apr. 12, 2024.

(51) Int. Cl. A63B 24/00

(52) U.S. Cl. CPC A63B 24/0062; A63B 2220/10; A63B 2220/40; A63B 2220/51; A63B 2220/833; A63B 2220/836; A63B 2225/50

(57) ABSTRACT

The present invention relates to a system designed to collect fitness data during strength training exercises and transmit this data to a receiving computer, such as a laptop or smartphone, via wireless or wired communication. The system comprises a central computing device that can be mounted to various attachment points suitable for different exercise types. Certain attachments include force sensing elements that, when connected to the central computing device, enable the transmission of force readings. These readings, combined with device displacement, allow for the calculation of work performed.

### CROSS-REFERENCE TO RELATED APPLICATION

The present application claims priority to and the benefit of U.S. Provisional Application No. 63/633,481, filed Apr. 12, 2024, the contents of which are incorporated herein by reference and made a part hereof.

### BACKGROUND OF THE INVENTION

The present invention generally relates to fitness equipment and health monitoring. More specifically the present invention relates to a modular fitness monitoring system and attachments configured for use with existing fitness equipment and free weights.

Fitness monitoring of the prior art typically comprises a plurality of software applications “apps,” wearable devices, and fitness equipment having integrated physical or health tracking software. Apps may be configured for manual entry of workout data or may be linked to an external device such as a wearable device, phone sensors, or equipment sensors. Wearable devices are typically used to track motion and vitals of the wearer during a particular exercise. External equipment may be configured to track vitals, weight, and rep counts.

Wearable devices are moveable and adaptable, but have not been fully utilized to track metrics needed for strength training. Free weights and cable equipment with integrated monitoring systems are expensive to invest in as well as subject to high maintenance and obsolescence costs.

The present invention overcomes the shortcomings of these previous systems by presenting a modular fitness monitoring system and adaptable devices configured to couple to and record fitness data from existing free weights and exercise equipment.

### SUMMARY OF THE INVENTION

In view of the above, the invention comprises a modular fitness monitoring system. The system is designed to collect data from a wide range of resistance training exercises, including those performed on commercial gym machines, home gym equipment, and callisthenic exercises, providing real-time, useful data presentation. The system comprises a central computing device coupled to at least one of a variety of attachments devices suitable for different exercises. The central computing device may be coupled to attachment devices that measure force and acceleration during strength training exercises and transmit this data to a receiving computer via wireless or wired communication. These readings, combined with device displacement, allow for the calculation of work performed. In configurations without force sensors, force and work are derived from device displacement and user-entered weight values.

In some aspects the attachment devices do not contain force sensors, and in such applications force and work is derived from device displacement and user entered weight values.

An alternative implementation uses a smartphone for user input and data storage, with necessary sensors transmitting data through a wired connection.

In some aspects system comprises a local computer or external computing device or a backend cloud server and networked devices configured with a graphical user interface (GUI) and plurality of communicatively coupled software modules configured to receive and collect and store pertinent workout data and analyze said data.

It is to be recognized by one of skill in the art that the terms “software,” “app,” “module,” “routine,” or “sub-routine” may be used interchangeably in this specification to describe a software or component parts thereof. In some embodiments of the present invention, each described module or routine/sub-routine is a component part of a larger set of software instructions while in other embodiments each described module or routine/sub-routine act as independent software applications. It is also to be recognized by one of skill in the art that the term “database” as used may describe a single specific database, or a sub-section of a larger database.

The methods, systems, apparatuses are set forth in part in the description which follows, and in part will be obvious from the description, or can be learned by practice of the methods, apparatuses, and systems. The advantages of the methods, apparatuses, and systems will be realized and attained by means of the elements and combinations particularly pointed out in the appended claims. It is understood that both the foregoing general description and the following detailed description are exemplary and explanatory only and are not restrictive of the methods, apparatuses, and systems, as claimed.

### BRIEF DESCRIPTION OF THE DRAWINGS

In the accompanying figures, like elements are identified by like reference numerals among the several preferred embodiments of the present invention.

FIG. 1 illustrates an example of the central computing device.

FIGS. 2-6 illustrate example embodiments of inline attachment devices.

FIGS. 7-8 illustrate example embodiments of cable pull down attachment devices.

FIGS. 9-15 illustrate example embodiments of a hand pad sensor assembly.

FIGS. 16-18 illustrate example embodiments of a platform pad sensor assembly.

FIGS. 19-21 illustrate example embodiments of a foot pad sensor assembly.

FIGS. 22-23 illustrate example embodiments of a weight stack pin mount assembly.

FIGS. 24-25 illustrate example embodiments of a barbell collar mount assembly.

Other aspects and advantages of the present invention will become apparent upon consideration of the following detailed description, wherein similar structures have similar reference numerals.

### DETAILED DESCRIPTION OF THE PREFERRED EMBODIMENTS

The foregoing and other features and advantages of the invention will become more apparent from the following detailed description of an exemplary embodiment, read in conjunction with the accompanying drawings. The detailed description and drawings are merely illustrative of the invention rather than limiting, the scope of the invention being defined by the appended claims and equivalents thereof.

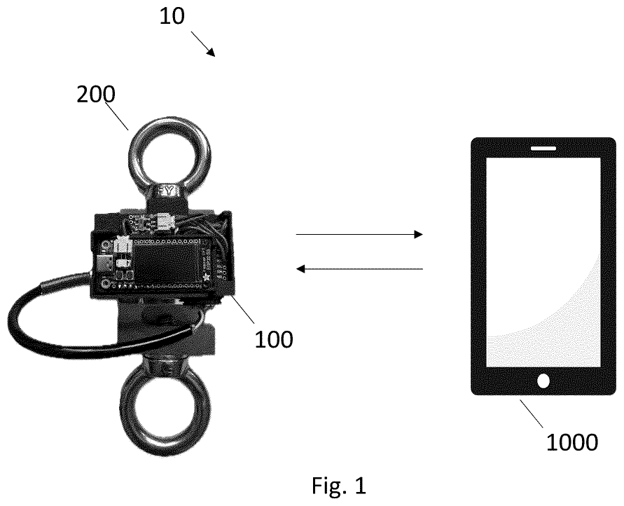

As shown in FIG. 1 the modular fitness monitoring system 10 comprises a central computing device 100 coupled to at least one attachment device 200, 300, 400, 500, 600, 700, 800 wherein the central computing device 100 is communicatively coupled to an external computing device 1000 and an external sensor device 900. In operation, the central computing device 100 is either coupled to the at least one attachment device 200, 300, 400, 500, 600, 700, 800 a piece of exercise equipment, or a wrist band, the central computing device 100 is communicatively coupled with the external sensor device 900 and collects data from the external sensor device while simultaneously collecting motion data, acceleration data, or position data. The central computing device 100 combines the data sources and either calculates work done internally or transmits that data to an external computing device 1000 for a workout analysis. Calculations may include but are not limited to work performed, force of exercise, energy used per rep or per exercise, and motion or range of exercise. The calculation data may be stored locally on the central computing device or in a software database on the external computing device 1000. The data may be shown or graphed through the external computing device 1000 software graphical user interface. One of skill in the art would recognize that an external computing device 1000 may include but is not limited to a phone, a tablet, a computer, or a backend server communicatively coupled to the central computing device 100. The external sensor device 900, may include but is not limited to load cells or strain gauges to measure applied external forces.

FIG. 1 shows an example embodiment of the central computing device 100. The central computing device 100 comprises a power source, a computing microcontroller or microprocessor, a load cell amplification chip, an accelerometer, a gyroscope, a power switch, a means for external communication with the external computing device 1000 and/or external sensor device 900, and a housing 102. The central computing device 100 power supply may be a rechargeable or replaceable battery internal to the housing 102 or may be an from an external power source electrically coupled to the central computing device 100 through either the means for external communication or a separate power/data connection as commonly used in industry.

The central computing device 100 means for external communication may comprise a wired data port or wireless connection configured to communicate with an external computing device 1000 and/or external sensor devices 900. In one example, central computing device 100 is coupled to the external sensor device 900 through industry standard connectors including but not limited to a bayonet-style connection, a TRRS jack, a brush-type connection, Universal Serial Bus (USB) or USB protocol variants, Lightening connector, or a pogo pin implementation. In other examples the central computing device 100 is connected with the external computing devices 1000 or external sensor device 900 through a wireless transmitter or radio connection including but not limited to Bluetooth, BLE, WiFi, LoRa, NFC, or Cellular connections. In operation, the central computing device 100 transmits information packets containing data collected during an exercise through the central computing device 100 and through the external sensor devices 900 such as acceleration, force, and time data at a rapid rate of speed to the external computing device 1000 to store and analyze. It should be recognized by one of skill in the art that a wired means for external communication as described above could be used for data or power transmission or both simultaneously. Further it would be recognized by one of skill in the art that the central computing device 100 may comprise separate wired data ports for external connection to a power source, external sensor device, and/or external computing device 1000.

The central computing device 100 is coupled to a mounting point of an external attachment device 200, 300, 400, 500, 600, 700, 800 that moves along an axis of exercise to capture the movement. In some aspects, the external sensing device 900 is coupled to the attachment device 200, 300, 400, 500, 600, 700, 800 and electronically or communicatively coupled to the central computing device 100. Further, in some aspects the central computing device 100 is coupled to the attachment device 200, 300, 400, 500, 600, 700, 800 through a spring loaded ball detent that securely attaches the central computing device 100 to the attachment device 200. The spring loaded ball coupling allows for stability, but also allows for decoupling without excessive force. One of skill in the art would recognize that the central computing device 100 may be coupled to the attachment device through other common removable coupling means such as fasteners, snaps, or magnets.

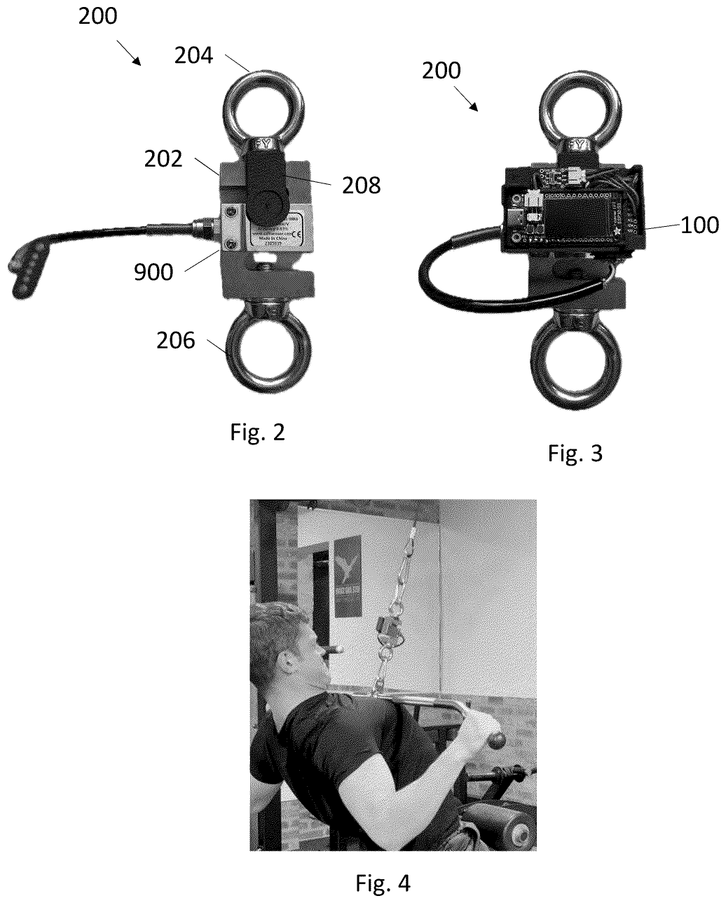

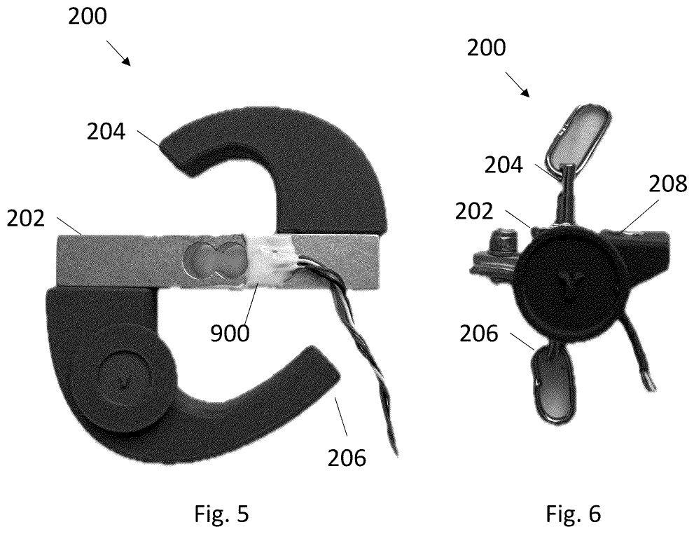

As shown in FIGS. 2-4, in one aspect the system 10 is configured to be coupled to fitness equipment comprising an inline cable. In this aspect, the at least one attachment device 200 comprises a body member 202 a cable connector 204, a pull connector 206, an external sensor device 900 such as a load cell or plurality of strain gauges coupled to the body member 202, and a central computing device mount 208. In this aspect, the cable connector 204 is coupled to the fitness equipment cable, the pull connector 206, is coupled to a pull member such as a bar or handle, the central computing device 100 is removably coupled to the central computing device mount 208, and electrically coupled to the external sensor device 900. In operation, the user performs a rep and pulls down on the pull member to begin the rep and slowly releases to control and end the rep causing strain on the body member 202 by the pull and release force, which in turn causes the external sensor device 900 to transmit strain/force data to the central computing device 100. The central computing device in concurrently records the time length of the rep as well as the position and acceleration of the central computing device 100 and combines and transmits all data sets to the external computing device 1000. In some aspects the central computing device 100 calculates work completed, in other aspects an associated app on the external computing device calculates the work with the raw data received. Other variations are shown in FIGS. 5 and 6 and are configured for additional pull strength.

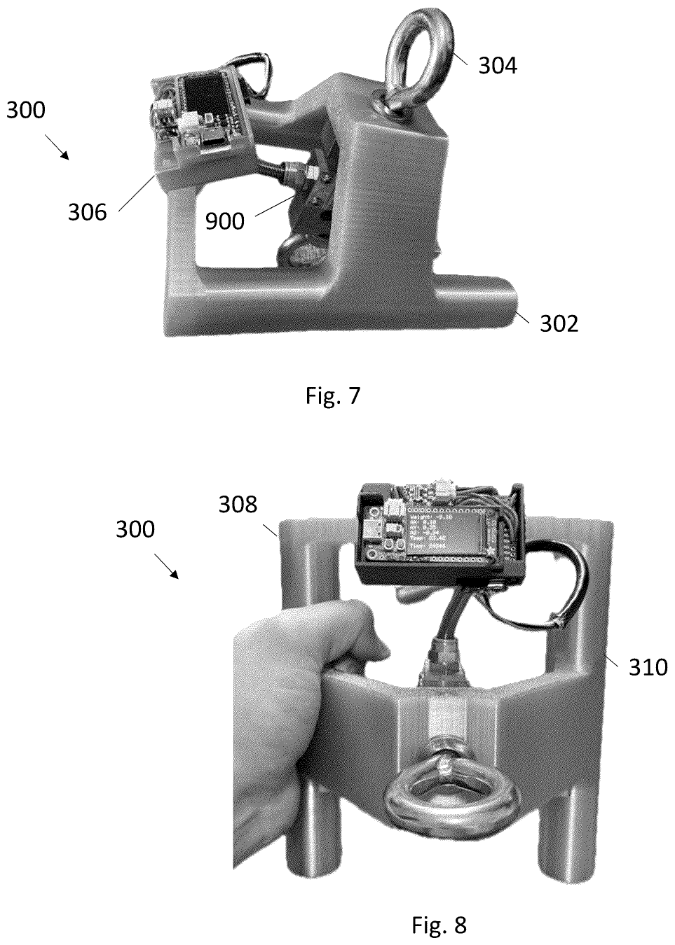

As shown in FIGS. 7-8, in another aspect, the at least one attachment device 300 comprises a body member 302 a cable connector 304, an external sensor device 900 such as a load cell or plurality of strain gauges coupled to the body member 302, and a central computing device mount 306. The body member 302, in this aspect acts as the pull member and comprises a pair of handles 308, 310. In this aspect, the cable connector 304 is coupled to the fitness equipment cable, and the body member 302 acts as the pull member, the central computing device 100 is removably coupled to the central computing device mount 306, and electrically coupled to the external sensor device 900. In operation, the user performs a rep and pulls down on the handles 308, 310 to begin the rep and slowly releases to control and end the rep causing strain on the body member 302 by the pull and release force, which in turn causes the external sensor device 900 to transmit strain/force data to the central computing device 100. The central computing device concurrently records the time length of the rep as well as the position and acceleration of the central computing device 100 and combines and transmits all data sets to the external computing device 1000. In some aspects the central computing device 100 calculates work completed, in other aspects an associated app on the external computing device calculates the work with the raw data received.

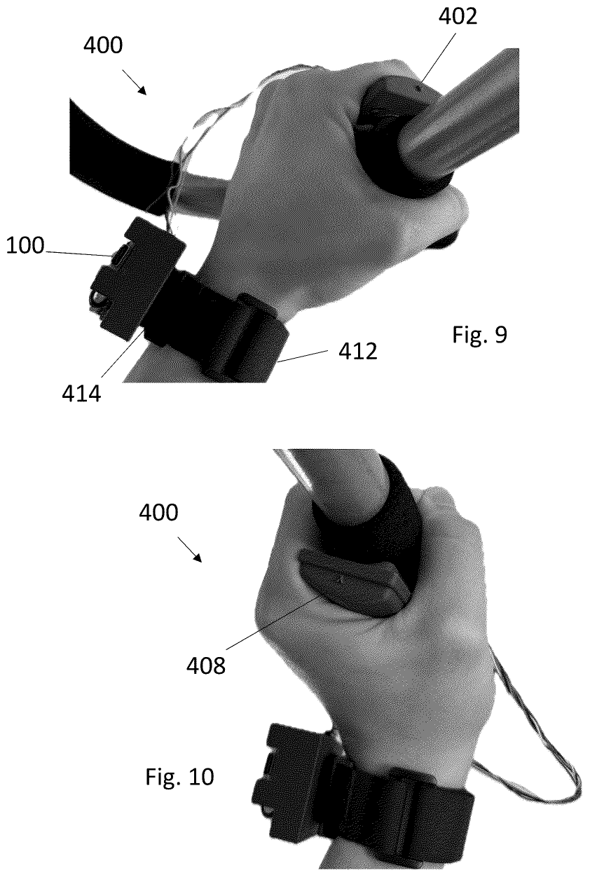

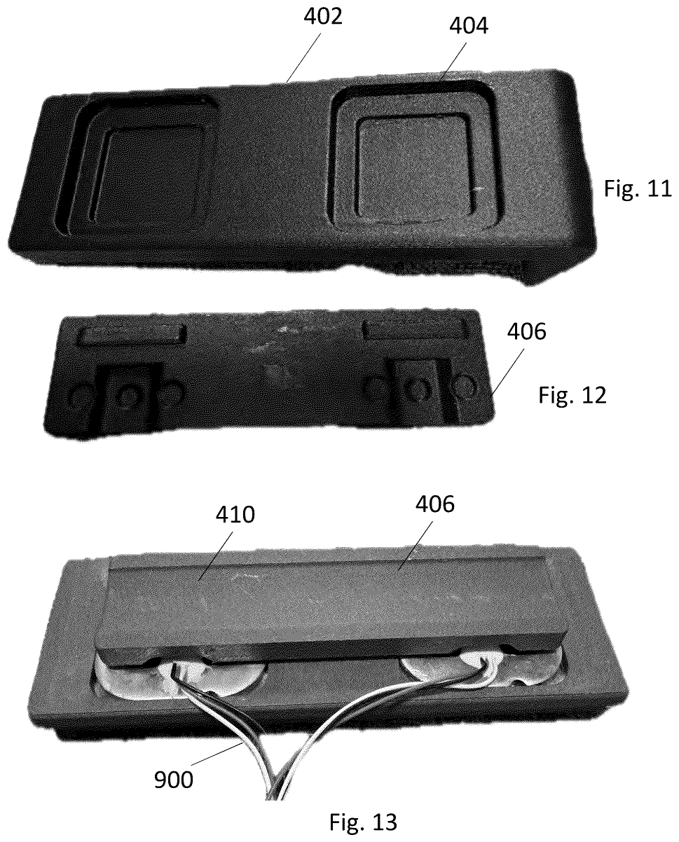

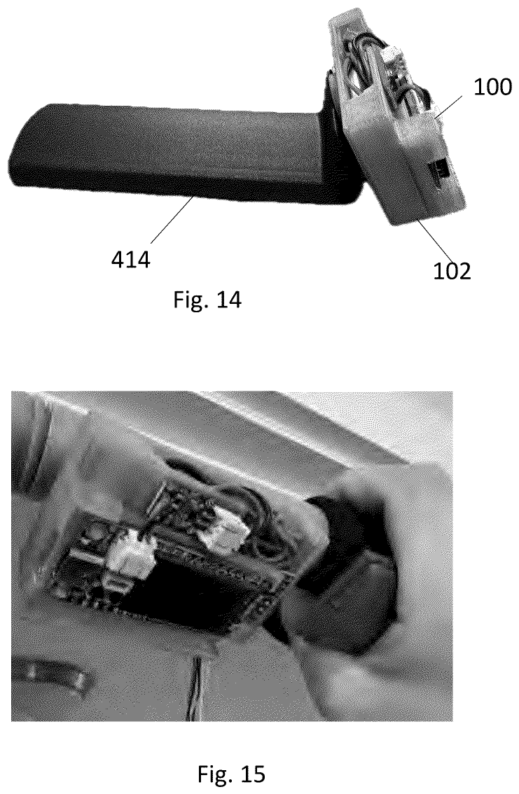

As shown in FIGS. 9-15, in yet another aspect, the at least one attachment device 400 comprises a hand pad sensor assembly. The hand pad sensor assembly 400 allows for collecting force and acceleration data by using force sensors in a custom designed enclosure to capture the force transmitted through pushing or pulling barbell-sized handles. The hand pad sensor assembly 400 comprises a body member 402, and an external sensor device 900 coupled to or disposed with the body member 402. In some aspects the body member 402 comprises at least one depression or pocket 404 configured to receive the external sensor device 900 and a cover member 406 to secure the external sensor member 500. Other embodiments may feature a ball or point end for the purpose of massage and physical therapy. In some aspects, the hand contact surface 408 may be curved or contoured to fit the curve of the palm or fingers in grip and the bar contact surface 410 may be curved or contoured to accommodate the curvature of a barbell, dumbbell, or pull up bar. The central computing device 100 may be mounted to a user's wristband 412 in some configurations, mounted to the hand pad body mount 414 in other configurations, or even mounted to the bar itself. The wristband 412 configuration may track the motion of the arms or wrists, while the mount 414 configuration may track the motion of the bar. In operation, the user mounts the central computing device 100 to either the hand pad body mount 414 or the wristband 412, couples the external sensor device 900 to the central computing device, aligns the bar contact surface 410 with the barbell, dumbbell, or pull up bar, grips the hand contact surface 408, performs the rep, as the user applies pressure to the barbell, dumbbell, or pull up bar during the rep, the external force sensor device 900 records the data and communicates it to the central computing device 100. The central computing device 100 concurrently records the time length of the rep as well as the position and acceleration of the central computing device 100 and combines and transmits all data sets to the external computing device 1000. In some aspects the central computing device 100 calculates work completed, in other aspects an associated app on the external computing device calculates the work with the raw data received. One hand pad sensor assembly 400 may be used on its own for asymmetric exercise or alternatively, two active hand pad sensor assemblies 400 may be coupled and attached to one computing device 100. Additionally, two active hand pad sensor assemblies 400 may be mounted to two computing devices 100, and the app will be able to record each data stream independently.

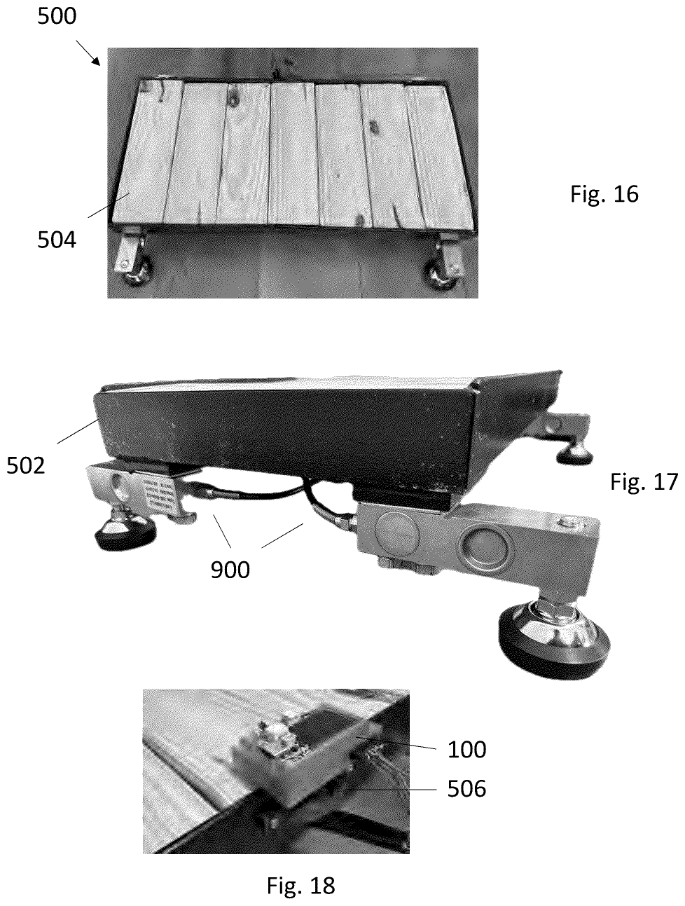

As shown in FIGS. 16-18, in another aspect, the at least one attachment device 500 comprises a platform sensor assembly. The platform sensor assembly 500 is a flat platform designed to measure force when performing compound leg movements such as squats or deadlifts. The platform sensor assembly 500 comprises a platform body 502, a plurality of external sensor devices 700 spread through the platform body 502, and a platform 504 disposed within the platform body 502 coupled to the plurality of external sensor devices 700. The central computing device 100 may be mounted to a user's wristband in some configurations or mounted to a platform body mount 506. One of skill in the art would recognize that the platform 504 and the platform body 502 may be a single integrated member. In operation, the user mounts the central computing device 100 to either the platform body mount 506 or the wristband 508 to track user motion, couples the external sensor device 900 to the central computing device 100, stands on the platform 504, performs the rep, as the user applies pressure to the platform during the rep, the external force sensors 700 record the data and communicate it to the central computing device 100. The central computing device 100 concurrently records the time length of the rep as well as the position and acceleration of the central computing device 100 and combines and transmits all data sets to the external computing device 1000. In some aspects the central computing device 100 calculates work completed, in other aspects an associated app on the external computing device calculates the work with the raw data received.

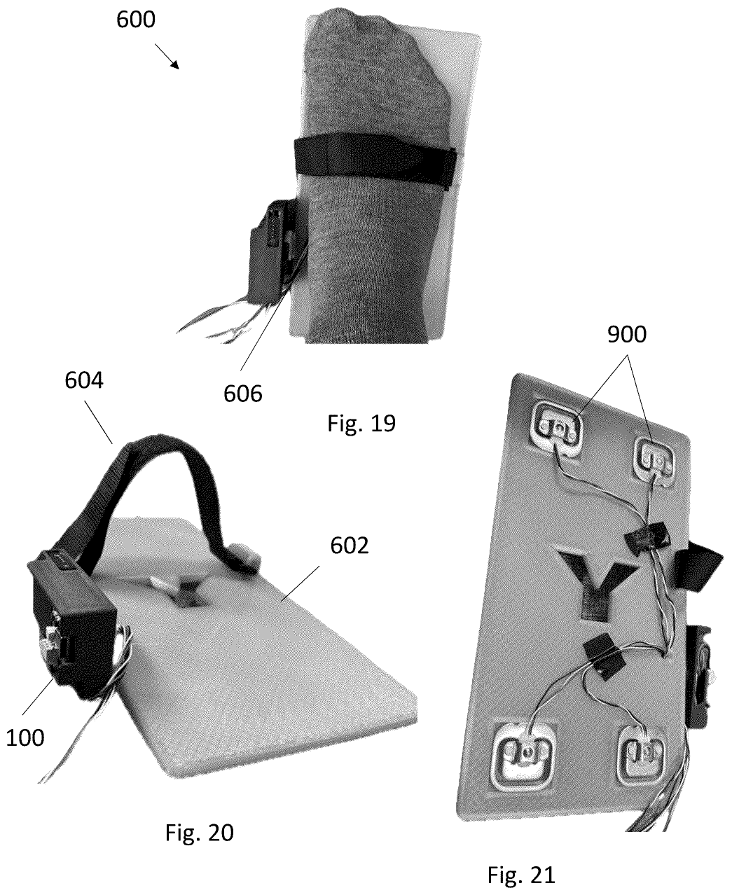

As shown in FIGS. 19-21, in yet another aspect, the at least one attachment device 600 comprises a foot pad sensor assembly. The foot pad sensor assembly 600 is a flat platform designed to measure force when performing compound leg movements such as squats or deadlifts, but designed to be portable and secure to each foot as opposed to being a larger platform. The foot pad sensor assembly 600 comprises a foot pad platform body 602, a plurality of external sensor devices 700 disposed with or on the bottom of the foot pad platform body 602, and a platform strap 604 configured to secure the user to the foot pad platform body 602. The central computing device 100 may be mounted to a user's wristband in some configurations or mounted to a foot pad platform body mount 606. In operation, the user mounts the central computing device 100 to either the foot pad platform body mount 606 or the wristband to track user motion, couples the external sensor devices 700 to the central computing device 100, straps into the foot pad platform body 602, stands on the foot pad platform body 602, performs the rep, as the user applies pressure to the foot pad platform body 602 during the rep, the external force sensors 700 record the data and communicate it to the central computing device 100. The central computing device 100 concurrently records the time length of the rep as well as the position and acceleration of the central computing device 100 and combines and transmits all data sets to the external computing device 1000. In some aspects the central computing device 100 calculates work completed, in other aspects an associated app on the external computing device 1000 calculates the work with the raw data received. One foot pad sensor assembly 600 may be used on its own for asymmetric exercise such as lunges, or used in conjunction with a “dummy” pad to equalize height during symmetrical exercise such as squats. Alternatively, two active foot pad sensor assemblies 600 may be coupled and attached to one computing device 100. Additionally, two active foot pad sensor assemblies 600 may be mounted to two computing devices 100, and the app will be able to record each data stream independently.

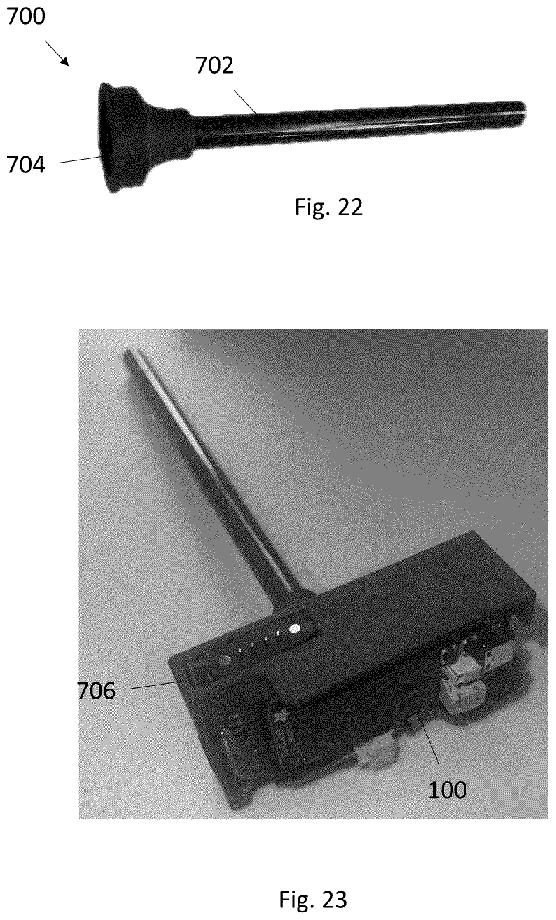

In yet another aspect, as shown in FIGS. 22-23, the at least one attachment device 700 comprises a weight stack pin mount assembly. The weight stack pin mount assembly 700 comprises a pin member 702, an end cap 704, and a weight stack body mount 706 configured to couple the central computing device 100 to the end cap 704. In some aspects the pin member 702 comprises integrated external sensor device 900 configured to record the weight load applied to the pin member 702 is a dummy pin simply configured to couple to the weight stack body mount 706. In operation, the user mounts the central computing device 100 to weight stack body mount 706 and the weight stack body mount to the end cap 704 if the mount 706 is not integrated into the end cap 704, couples the external sensor device 900 to the central computing device 100, performs the rep, as the user performs the rep the external force sensors 900 record the force/weight data and communicate it to the central computing device 100. The central computing device 100 concurrently records the time length of the rep as well as the position and acceleration of the central computing device 100 and combines and transmits all data sets to the external computing device 1000. In aspects that use a dummy pin, only the position and acceleration data is recorded, and weight data can be entered in manually on the external computing device 1000 or the central computing device 100.

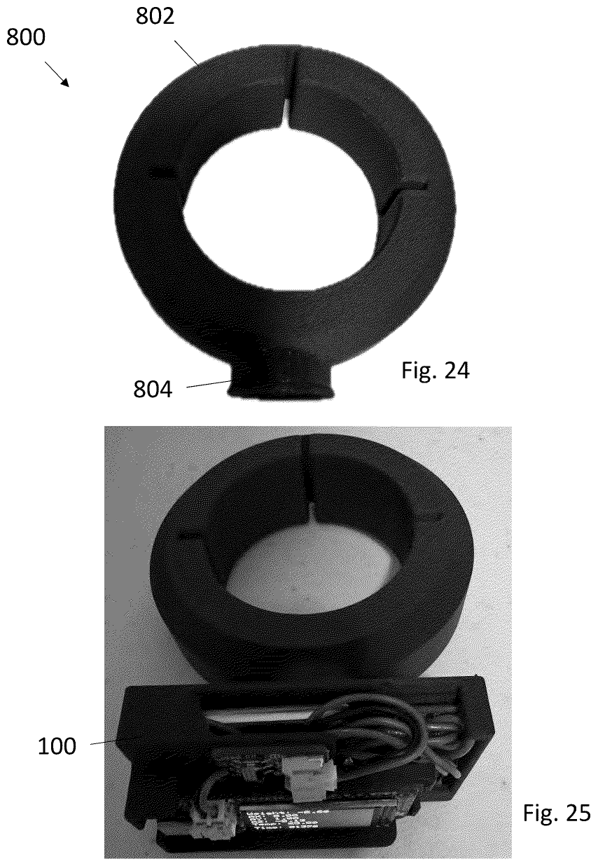

In yet another aspect a shown in FIGS. 24-25, the at least one attachment device 800 comprises a barbell collar mount assembly. The barbell collar mount assembly 800 comprises a barbell collar mount body 802 configured to couple to a barbell end and a barbell collar mount 804 configured to couple to the central computing device 100. In operation, the user mounts the central computing device 100 to collar body mount body mount 802 and the collar body 802 to the barbell end, performs the rep, as the user performs the rep the central computing device 100 concurrently records the time length of the rep as well as the position and acceleration of the central computing device 100 and combines and transmits all data sets to the external computing device 1000. The weight data can be entered in manually on the external computing device 1000 or the central computing device 100.

In other aspects of the system 10, the external sensor device 900 is integrated into the equipment itself instead an attachment device. In one example, the external sensor device 900 is coupled into the terminal ball of cable machines or the cable connection at the weigh stack interface. Integration without an attachment sacrifices modularity, but addresses the addition of cable length and reduced range of motion by adding the system 10 in line. In this aspect, external sensor device 900 would comprise miniaturized strain gauges within these existing connection points and the central computing device 100 may me coupled at the cable end and mounted thereto.

In yet another aspect the system comprises a method to calculate work performed, position, exercise path, or range of motion in strength training comprising the steps of coupling the central computing device 100 to an attachment device 200, 300, 400, 500, 600, 700, 800, coupling the central computing device 100 to the external sensor device 900, coupling the attachment device to a piece of exercise equipment, performing the rep, collecting force data from the external sensor device 900, collecting position or acceleration data from the central computing device 100, transmitting the collected data from the central computing device 100 to an external computing device 1000, calculating work performed, position, exercise path, or range of motion on the external computing device 1000. In other aspects, the method includes the step of displaying the data through the external computing device 1000 graphical user interface. In an alternative method, the calculation is performed locally on the central computing device 100.

Those of ordinary skill in the art will understand and appreciate the aforementioned description of the invention has been made with reference to a certain exemplary embodiment of the invention, which describe a modular fitness monitoring system and method of use. Those of skill in the art will understand that obvious variations in construction, material, dimensions or properties may be made without departing from the scope of the invention which is intended to be limited only by the claims appended hereto.

1. A modular fitness monitoring system comprising:
a central computing device;
an attachment device;
an external sensor device; and
wherein the central computing device is coupled to the attachment device and the external sensor device, the attachment device is coupled to a fitness equipment, and the central computing device is configured to collect fitness rep acceleration and position data, the external sensor device is configured to transmit force data to the central computing device, and the central computing device is configured to transmit the force data and the fitness rep acceleration and position data to an external computing device.

2. The modular fitness monitoring system of claim 1 wherein the central computing device comprises a power source, a computing microcontroller or microprocessor, a load cell amplification chip, a wireless transmitter or data port, and at least one of an accelerometer or gyroscope.

3. The modular fitness monitoring system of claim 2 wherein the wherein the wireless transmitter comprises at least one of a Bluetooth, BLE, WiFi, LoRa, NFC, or Cellular radio.

4. The modular fitness monitoring system of claim 2 wherein the wherein the external device includes at least one of a phone, tablet, computer, or cloud server.

5. The modular fitness monitoring system of claim 2 wherein the external sensor device comprises at least one load cell or strain gauge.

6. The modular fitness monitoring system of claim 5 wherein the external sensor device measures the load applied to the attachment device or strain applied to the attachment device during a fitness rep.

7. The modular fitness monitoring system of claim 5 wherein the attachment device comprises a hand pad sensor assembly, the hand pad sensor assembly comprising:
a hand pad body member;
at least one depression or pocket configured to accommodate the external sensor device; and
a cover member configured to secure the external sensor device in the hand pad body member.

8. The modular fitness monitoring system of claim 7 wherein the system further comprises a wristband and the central computing device is coupled to the wristband.

9. The modular fitness monitoring system of claim 8 wherein the system further comprises a hand pad sensor body mount extending from the hand pad body configured to couple to the central computing device.

10. The modular fitness monitoring system of claim 7 wherein the hand pad body member further comprises ball or point end features.

11. The modular fitness monitoring system of claim 7 wherein the hand pad body member comprises a hand contact surface configured to curve to the contour of a hand.

12. The modular fitness monitoring system of claim 7 wherein the hand pad body member or cover member comprises a bar contact surface configured to curve to the contour of a fitness equipment bar.

13. The modular fitness monitoring system of claim 7 wherein the hand pad body member or cover member comprise a flat surface.

14. The modular fitness monitoring system of claim 7 wherein the external sensor device is configured to transmit force data to the central computing device measuring the force applied to the hand contact surface during a fitness rep.

15. The modular fitness monitoring system of claim 14 comprising a second hand pad sensor assembly wherein the second hand pad sensor assembly is coupled to the central computing device or a second central computing device configured to transmit force data from each hand.

16. A method to calculate work performed, position, exercise path, or range of motion in strength training comprising the steps of:
coupling a central computing device to an attachment device;
coupling the attachment device to an external sensor device;
coupling the attachment device to a piece of fitness equipment;
performing a fitness rep on the piece of fitness equipment;
collecting force data from the external sensor device as applied through the attachment device during the fitness rep and transmitting it to the central computing device;
collecting positional data and acceleration data from the central computing device through motion sensors of the central computing device during the fitness rep;
transmitting the force data, positional data, and acceleration data from the central computing device to an external computing device.

17. The method of claim 16 wherein the external sensor device comprises a load cell or strain gauge.

18. The method of claim 17 wherein the attachment device comprises a hand pad sensor assembly, the hand pad sensor assembly comprising:
a hand pad body member;
at least one depression or pocket configured to accommodate the external sensor device; and
a cover member configured to secure the external sensor device in the hand pad body member.
